(19) United States
(12) Patent Application Publication
(10) Pub. No.: US 2026/0323219 A1
(43) Pub. Date: Oct. 15, 2026

(54) MULTI-MAGNETIC-CIRCUIT LOUDSPEAKER, AND VEHICLE AUDIO SYSTEM

(71) Applicant: Suzhou Sonavox Electronics Co., Ltd., Suzhou, Jiangsu (CN)

(72) Inventors: Peng Gao, Suzhou, Jiangsu (CN); Zhanqing Dong, Suzhou, Jiangsu (CN); Zhenyu Tang, Suzhou, Jiangsu (CN); Hanyu Gu, Suzhou, Jiangsu (CN); Xiafeng Xue, Suzhou, Jiangsu (CN); Xianliang Mei, Suzhou, Jiangsu (CN)

(21) Appl. No.: 19/482,699

(22) PCT Filed: Oct. 30, 2023
(86) PCT No.: PCT/CN2023/127715

§ 371 Date: Nov. 7, 2025

(30) Foreign Application Priority Data
May 8, 2023 (CN) 202321071714.2

(51) Int. Cl. H04R 9/02; H04R 7/18; H04R 9/04

(52) U.S. Cl. CPC H04R 9/025; H04R 7/18; H04R 9/043; H04R 9/045; H04R 2400/11; H04R 2499/13

(57) ABSTRACT

Disclosed are a multi-magnetic circuit loudspeaker and an automotive audio system. The multi-magnetic circuit loudspeaker includes a frame; a diaphragm, having an outer edge connected to an upper end portion of the frame; a plurality of voice coils, an upper end portion of each of the plurality of voice coils being connected to the diaphragm; a magnetic circuit assembly, having a plurality of magnetic gaps. The magnetic circuit assembly includes a yoke connected to the frame and a plurality of magnet assemblies disposed within the yoke, the yoke including a plurality of cavities, each of the cavities being provided with one of the magnet assemblies. The yoke includes a connecting channel located between the plurality of cavities and communicating the plurality of cavities.

### CROSS-REFERENCE TO RELATED APPLICATION

This application claims the benefit of priority from Chinese Patent Application No. CN 202321071714.2, filed on May 8, 2023; the entire contents of which are incorporated herein by reference.

### FIELD OF TECHNOLOGY

The present disclosure relates to a loudspeaker, and particularly to a multi-magnetic circuit loudspeaker and an automotive audio system having the same.

### BACKGROUND

A loudspeaker generally includes a diaphragm, a voice coil, a spider, and a magnetic drive unit, etc.

However, for automotive loudspeakers used to constitute an automotive audio system on a roof or headrest of the automobile, it is required to have characteristics such as light weight, small size, high power, and a good low-frequency limit. Conventional loudspeakers, generally with a single spider, are usually heavy, bulky, and require large installation depth. Although loudspeakers with no spider are light and small, but they have low power. Neither of these two types of conventional loudspeakers is suitable for use as the loudspeakers of the automotive audio system on a roof or headrest of the automobile.

Currently, there is a type of multi-input loudspeaker including multiple magnetic drive unit s, each magnetic drive unit drives one voice coil, and multiple voice coils jointly driving one diaphragm to vibrate, which increases power, and the loudspeaker will not occupy excessive space, achieves the function of a miniaturized and high-power. This type of loudspeaker can also be installed in narrow spaces, saving space within the automobile and increasing low-frequency volume of the loudspeaker.

However, this loudspeaker has some drawbacks, each magnetic drive unit includes a yoke and a magnet assembly accommodated within the yoke, and a voice coil is inserted into each yoke. The total heat generated is significant, leading to defects such as poor heat dissipation, inconvenient assembly, and poor structural stability.

### SUMMARY

The present disclosure relates to a multi-magnetic circuit loudspeaker and an automotive audio system having the multi-magnetic circuit loudspeaker.

A first aspect of the present disclosure provides a multi-magnetic circuit loudspeaker, which includes:
a frame;
a diaphragm, having an outer edge connected to an upper end portion of the frame;
a plurality of voice coils, an upper end portion of each of the plurality of voice coils being connected to the diaphragm;
a magnetic circuit assembly, having a plurality of magnetic gaps;
wherein each of the voice coils corresponds to one of the magnetic gaps and is inserted into the corresponding magnetic gap;
the magnetic circuit assembly includes a yoke connected to the frame and a plurality of magnet assemblies disposed within the yoke, the yoke including a plurality of cavities, each of the cavities being provided with one of the magnet assemblies, the magnetic gaps being formed between side walls of the cavities and outer side surfaces of the magnet assemblies located therein; the yoke including a connecting channel located between the plurality of cavities and communicating the plurality of cavities.

In an embodiment, the yoke includes a bottom plate, a plurality of arc-shaped side walls and connecting plates extending upward from the bottom plate, adjacent arc-shaped side walls are connected by the connecting plates, each of the arc-shaped side walls enclosing one of the cavities, the connecting channel being enclosed by two or more of the connecting plates, and portions of the magnetic gaps being located between the arc-shaped side walls and the magnet assemblies

In an embodiment, a width of the connecting channel is less than diameters of the cavities.

In an embodiment, the arc-shaped side walls extend along circular arcs, central angles of the circular arcs are greater than or equal to 270 degrees and less than 360 degrees.

In an embodiment, two of the arc-shaped side walls are connected by two of the connecting plates, two cavities are communicated by one connecting channel, and the connecting channel is a straight channel.

In an embodiment, the multi-magnetic circuit loudspeaker further includes a spider and a connecting bracket, the spider being fixed to the frame, an upper end portion of the connecting bracket being fixed to the diaphragm, and a lower end portion of the connecting bracket being fixed to the spider.

In an embodiment, the multi-magnetic circuit loudspeaker includes a plurality of spiders symmetrically disposed, the plurality of voice coils or the magnetic circuit assembly being located between the plurality of spiders, each of the spiders having an outer edge fixed to the frame and an inner edge adjacent to the voice coils or the magnetic circuit assembly, the lower end portion of the connecting bracket being fixed to the inner edge of each of the spiders.

In an embodiment, the frame is provided with a pair of solder terminals, one lead wire of each of the voice coils is connected to one of the pair of solder terminals, and another lead wire of each of the voice coils is connected to the other solder terminal, the plurality of voice coils are connected to each other in series or in parallel.

In an embodiment, the frame includes a first frame and a second frame that are stacked, magnetic circuit mounting holes being arranged on the first frame and the second frame respectively, the yoke being disposed in the magnetic circuit mounting holes and fixed to hole walls of the magnetic circuit mounting holes.

In an embodiment, the multi-magnetic circuit loudspeaker further includes a spider and a connecting bracket, the first frame has a hole portion, an outer edge of the spider is fixed to a lower surface of the first frame, an inner edge of the spider is fixed to a lower end portion of the connecting bracket, the connecting bracket passes through the hole portion, and an upper end portion of the connecting bracket is fixed to the diaphragm.

In an embodiment, the second frame is provided with a vent hole, the multi-magnetic circuit loudspeaker further includes a cloth being sound-absorbing and breathable, the cloth covering the vent hole, the cloth being fixed to an outer surface or an inner surface of the second frame.

In an embodiment, the loudspeaker further includes a cable assembly, the cable assembly including cables and a connector, the cables being connected to the solder terminals.

In an embodiment, the magnetic circuit assembly includes a single yoke.

A second aspect of the present disclosure provides an automotive audio system, which includes the multi-magnetic circuit loudspeaker described above.

The present disclosure adopts the above solutions and has the following advantages:
in the multi-magnetic circuit loudspeaker of the present disclosure, the plurality of voice coils share one yoke, and the yoke is provided with a plurality of cavities which are communicated by a connecting channel, the voice coils reciprocate in their respective magnetic gaps to drive the diaphragm to vibrate and produce sound, and the heat generated can be dissipated through the connecting channel, thereby providing good heat dissipation performance, simplifying assembly, reducing the number of assembly fixtures used, and ensuring good structural stability.

### BRIEF DESCRIPTION OF THE DRAWINGS

To more clearly illustrate the technical solutions of the present disclosure, the drawings required for describing the embodiments will be briefly introduced below. Obviously, the drawings in the following description are only some embodiments of the present disclosure. For those of ordinary skill in the art, other drawings can be obtained based on these drawings without creative effort.

FIG. 1 is an exploded view of a multi-magnetic circuit loudspeaker according to an embodiment of the present disclosure;

FIG. 2 is a top view of the multi-magnetic circuit loudspeaker according to an embodiment of the present disclosure, wherein the cable assembly is not shown;

FIG. 3 is a sectional view along line A-A in FIG. 2;

FIG. 4 is a sectional view along line B-B in FIG. 2;

FIG. 5 is a structural view of a yoke according to an embodiment of the present disclosure;

FIG. 6 is a comparison diagram of frequency response curves between an embodiment and a comparison example;

FIG. 7 is a comparison diagram of distortion curves between an embodiment and a comparison example.

Reference numerals are as follows:

1—frame; 11—first frame; 111—magnetic circuit mounting hole; 112—hole portion; 12—second frame; 121—vent hole; 13—front cover plate; 2—diaphragm; 21—surround; 211—striped pattern; 22—main body; 3—voice coil; 31—lead wire; 4—magnetic circuit assembly; 41—magnetic gap; 42—yoke; 421—cavity; 422—connecting channel; 423—bottom plate; 424—side wall; 425—connecting plate; 43—magnet assembly; 431—first magnet; 432—front plate; 433—second magnet; 5—spider; 51—outer edge; 52—inner edge; 6—connecting bracket; 7—solder terminal; 9—sound-absorbing and breathable cloth; 10—cable assembly; 101—cable; 102—connector.

### DETAILED DESCRIPTION

The preferred embodiments of the present disclosure will be described in detail below with reference to the accompanying drawings, so that the advantages and features of the present disclosure can be more easily understood by those skilled in the art. It should be noted that the descriptions of these embodiments are intended to help understand the present disclosure, but do not constitute a limitation on the present disclosure. In addition, the technical features involved in the various embodiments of the present disclosure described below can be combined with each other as long as they do not conflict with each other.

In the present disclosure, “inner” and “outer” are defined with reference to the centerline of the respective corresponding voice coil. The orientation closer to the centerline of the voice coil is inner, and vice versa. The orientation words “upper”, “lower”, and “horizontal” are intended to facilitate the understanding of the loudspeaker's structure by those skilled in the art, and are not intended to limit the state of the loudspeaker after it is installed in a usage scenario (such as a vehicle); for example, the loudspeaker can be installed on an inclined component, a vertical component, or the lower surface of a component.

This embodiment provides a multi-magnetic circuit loudspeaker and an automotive audio system having the multi-magnetic circuit loudspeaker. The multi-magnetic circuit loudspeaker will be described in detail below.

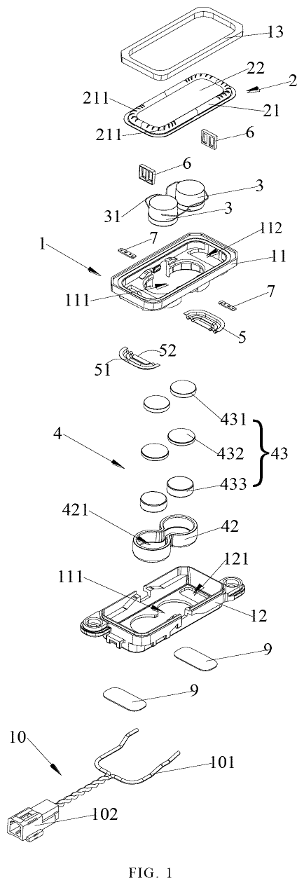

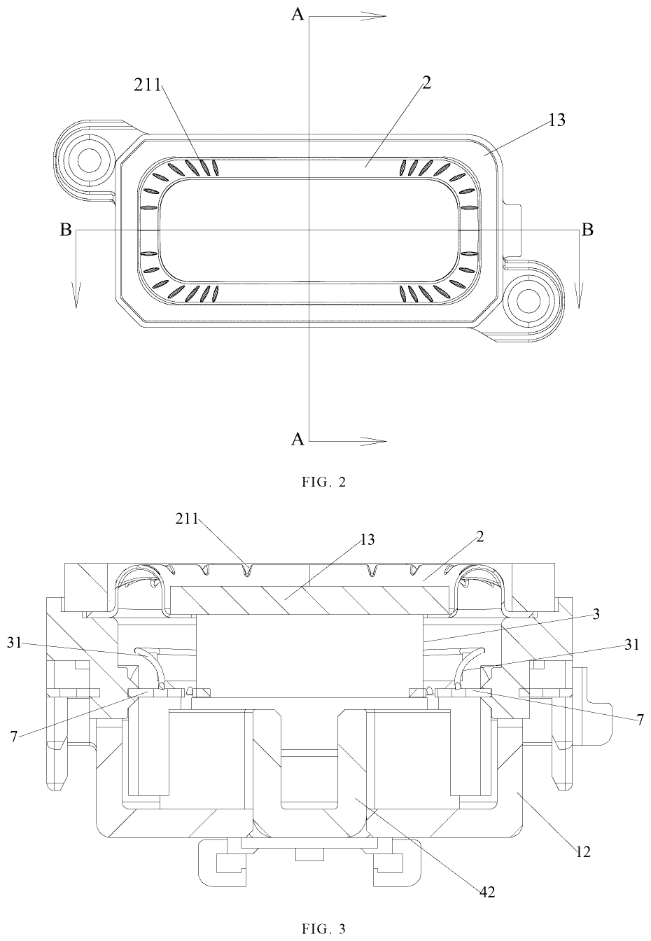

Referring to FIG. 1 to FIG. 5, the multi-magnetic circuit loudspeaker includes a frame 1, a diaphragm 2, a front cover plate 13, a plurality of voice coils 3, a magnetic circuit assembly 4, a plurality of spiders 5, a plurality of connecting brackets 6, and a cable assembly 10.

The diaphragm 2 has an outer edge connected to an upper end portion of the frame 1. Specifically, the diaphragm 2 includes a diaphragm main body 22 and a surround 21. The diaphragm main body 22 is plate-shaped, and in this embodiment, a multi-layer composite material paper diaphragm is specifically used. The diaphragm main body 22 is rectangular or rounded-rectangular overall. The surround 21 surrounds the diaphragm main body 22 and is glued and fixed to the frame 1 via the surround 21.

Viewed from a vertical cross-section of the surround 21, the middle portion of the surround 21 bulges upward. The four corner portions of the surround 21 are provided with downwardly recessed striped patterns 211, which can effectively improve the problem of folding at the corners when the diaphragm 2 vibrates up and down, effectively enhancing the balance and stability of vibration of the diaphragm 2, improving the loudspeaker's pure tone, distortion, and rocking, enabling the loudspeaker to achieve better acoustic performance.

Further, the front cover plate 13 is fixedly connected to the upper end portion of the frame 1 and presses the outer edge of the surround 21 tightly against the frame 1. The front cover plate 13 is ring-shaped with an open center, and does not obstruct the main part of the diaphragm 2, including the diaphragm main body 22 and the majority of the surround 21.

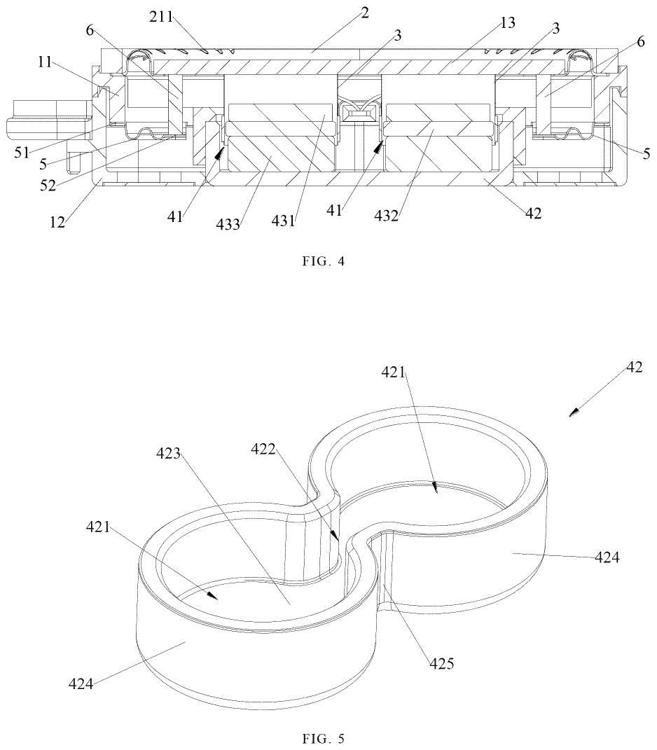

The number of voice coils 3 is specifically two, and the upper end portion of each voice coil 3 is connected to the diaphragm 2. Specifically, the two voice coils 3 are spaced apart along the length direction of the diaphragm 2, as shown in FIG. 4.

The magnetic circuit assembly 4 has a plurality of magnetic gaps 41. Each voice coil 3 corresponds to one magnetic gap 41 and is inserted into one corresponding magnetic gap 41 to drive the diaphragm 2 to vibrate and produce sound. As shown in FIG. 1 and FIG. 4, the magnetic circuit assembly 4 includes a yoke 42 connected to the frame 1 and a plurality of magnet assemblies 43 disposed within the yoke 42. The yoke 42 has a plurality of cavities 421. Each cavity 421 is provided with one magnet assembly 43. The magnetic gaps 41 are formed between the side walls of each cavity 421 and the outer side surfaces of the magnet assemblies 43 located therein. Specifically, corresponding to the number of voice coils 3, the number of magnetic gaps 41, magnet assemblies 43, and cavities 421 is also two.

Each magnet assembly 43 includes a first magnet 431, a second magnet 433, and a front plate 432 disposed between the two magnets. The first magnet 431, the front plate 432, and the second magnet 433 are sequentially stacked within the yoke 42. An upper surface of the front plate 432 is bonded to the first magnet 431, a lower surface of the front plate 432 is bonded to an upper surface of the second magnet 433, and a lower surface of the second magnet 433 is bonded to a bottom plate of the yoke 42.

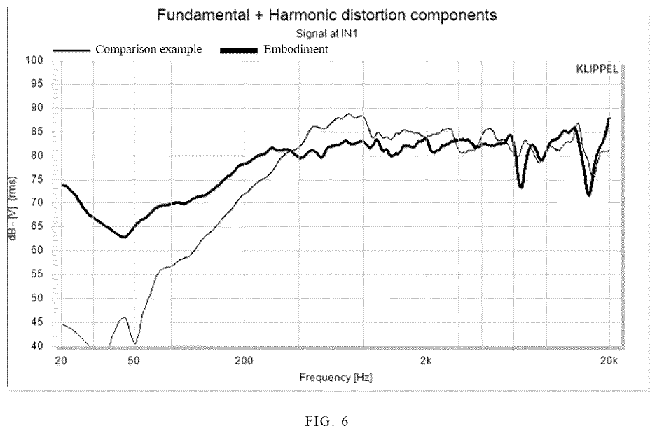

Referring to FIG. 5, the yoke 42 also has a connecting channel 422 located between the plurality of cavities 421 and communicating the plurality of cavities 421. A width of the connecting channel 422 is less than a diameter of the cavity 421 and less than an outer diameter of the magnet assembly 43.

The yoke 42 has a bottom plate 423, a plurality of arc-shaped side walls 424 extending upward from the bottom plate 423, and connecting plates 425. The arc-shaped side walls 424 extend along a circular arc, and a central angle of the circular arc is greater than or equal to 270 degrees and less than 360 degrees, further between 315 degrees and 350 degrees. Correspondingly, in a top view, the voice coil 3 and the magnetic gap 41 are annular, while the magnet assembly 43 is circular. The connecting plates 425 connect adjacent arc-shaped side walls 424. Each arc-shaped side wall 424 encloses one cavity 421. The two cavities 421 are communicated by one connecting channel 422, resulting in good heat dissipation performance for the loudspeaker, facilitating assembly, reducing the number of fixtures, and providing good structural stability. Further, the connecting channel 422 is enclosed by two connecting plates 425. The connecting channel 422 is a straight channel. A portion of the magnetic gap 41 is located between the arc-shaped side wall 424 and the magnet assembly 43.

Referring to FIG. 4, the spiders 5 are fixedly connected to the frame 1. An upper end portion of the connecting bracket 6 is fixedly connected to the diaphragm 2, and a lower end portion of the connecting bracket 6 is fixedly connected to the spider 5. The number of spiders 5 is two and they are symmetrically disposed. The plurality of voice coils 3 or the magnetic circuit assembly 4 are located between the two spiders 5. Each spider 5 has an outer edge 51 fixedly connected to the frame 1 and an inner edge 52 adjacent to the voice coils 3 or the magnetic circuit assembly 4. The shape of the outer edge 51 is arc-shaped or part of a rounded rectangle. The lower end portion of the connecting bracket 6 is fixedly connected to the inner edge 52 of the spider 5.

Referring to FIG. 1, the frame 1 is provided with a pair of solder terminals 7. One lead wire 31 of each voice coil 3 is connected to one solder terminal 7, and the other lead wire 31 of each voice coil 3 is connected to the other solder terminal 7. The plurality of voice coils 3 are connected to each other in series or in parallel. The cable assembly 10 includes cables 101 and a connector 102 connected to the cables 101. One cable 101 is connected to one solder terminal 7, and the other cable 101 is connected to the other solder terminal 7. The connector 102 is used to connect to a power amplifier or an audio processing chip, for accessing the audio source to be played.

Further, the frame 1 includes a first frame 11 and a second frame 12 that are stacked. The first frame 11 and the second frame 12 are generally rectangular-cuboid-shaped, so that the loudspeaker is rectangular-cuboid-shaped, enabling convenient installation in a vehicle without occupying excessive interior space. The first frame 11 and the second frame 12 are respectively provided with a magnetic circuit mounting hole 111. The yoke 42 is disposed in the magnetic circuit mounting hole 111 and fixedly connected to the hole wall of the magnetic circuit mounting hole 111.

The first frame 11 has a hole portion 112. The outer edge 51 of the spider is fixedly connected to a lower surface of the first frame 11. The inner edge 52 of the spider is fixedly connected to the lower end portion of the connecting bracket 6. The connecting bracket 6 passes through the hole portion 112, and its upper end portion is fixedly connected to the diaphragm 2. Specifically in this embodiment, the number of connecting brackets 6 is 2, and they are symmetrically distributed on the left and right sides of the loudspeaker. The first frame 11 is correspondingly provided with two such hole portions 112.

The second frame 12 is provided with a vent hole 121. The multi-magnetic circuit loudspeaker further includes a cloth 9 being sound-absorbing and breathable, the cloth 9 covers the vent hole 121. The cloth 9 is fixed to an outer surface or an inner surface of the second frame 12. The cloth 9 is a fabric material, having certain sound-absorbing and breathable functions.

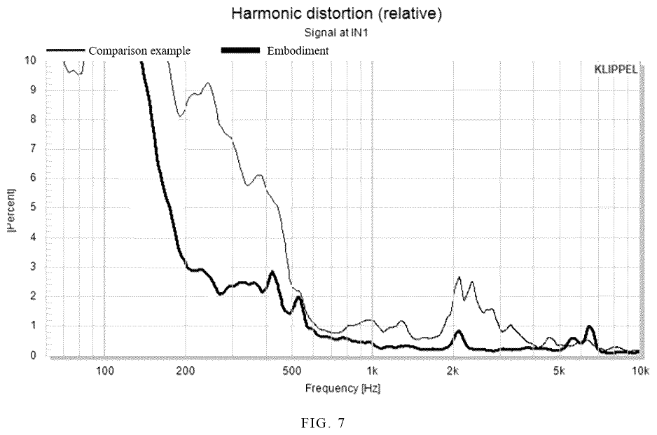

A conventional small-sized loudspeaker with a single magnetic circuit structure serves as a comparative example. The sound performance of the multi-magnetic circuit loudspeaker of the embodiment and the small-sized loudspeaker with a single magnetic circuit structure of the comparative example were compared. The comparison of frequency response curves and distortion curves is shown in FIG. 6 and FIG. 7, respectively. The aforementioned small-sized loudspeaker with a single magnetic circuit structure uses one voice coil and one magnetic circuit assembly with a single magnetic gap; other aspects are the same as the embodiment. As shown in FIG. 6, it can be seen from the frequency response curves that within the range of 200 Hz to 5 kHz, the curve of the embodiment is significantly smoother than that of the comparative example, its performance is more excellent, and the listening experience is better. As shown in FIG. 7, it can be seen from the distortion curves that the distortion of the embodiment is significantly lower than that of the comparative example.

The multi-magnetic circuit loudspeaker of this embodiment can solve the problem of having a wide frequency bandwidth in both low and high frequencies, has low distortion, and the dual-magnetic circuit structure design is more stable, facilitates heat dissipation, and the loudspeaker's performance is more excellent.

As indicated in this specification and the claims, the terms “comprising” and “including” merely indicate the inclusion of clearly identified steps and elements, and these steps and elements do not constitute an exclusive list; the method or apparatus may also include other steps or elements.

Those skilled in the art can understand that, unless specifically stated otherwise, the singular forms “a”, “an”, and “the” used herein may also include the plural forms. It can be further understood that the term “plurality” in the present disclosure refers to two or more, and other quantifiers are similar.

It can be further understood that terms such as “first”, “second”, etc., are used to describe various pieces of information, but this information should not be limited to these terms. These terms are only used to distinguish information of the same type from each other and do not indicate a specific order or degree of importance. In fact, expressions like “first”, “second”, etc., are completely interchangeable. For example, without departing from the scope of the present disclosure, first information may also be referred to as second information, and similarly, second information may also be referred to as first information.

In the present disclosure, unless otherwise explicitly specified and limited, “on” or “under” a second feature may include direct contact between the first and second features, or it may include indirect contact between the first and second features through another feature between them. Moreover, “on”, “above”, and “over” a second feature include the first feature being directly above or obliquely above the second feature, or simply indicating that the horizontal height of the first feature is greater than that of the second feature. “Under”, “below”, and “beneath” a second feature include the first feature being directly below or obliquely below the second feature, or simply indicating that the horizontal height of the first feature is less than that of the second feature.

The above embodiments are only for illustrating the technical concept and features of the present disclosure, and are preferred embodiments. Their purpose is to enable those skilled in the art to understand the content of the present disclosure and implement it, and they cannot be used to limit the protection scope of the present disclosure.

1. A multi-magnetic circuit loudspeaker, comprising:
a frame;
a diaphragm, having an outer edge connected to an upper end portion of the frame;
a plurality of voice coils, an upper end portion of each of the plurality of voice coils being connected to the diaphragm; and
a magnetic circuit assembly, comprising a plurality of magnetic gaps,
wherein each of the plurality of voice coils corresponds to one of the plurality of magnetic gaps and is inserted therein, and
wherein the magnetic circuit assembly comprises a yoke connected to the frame and a plurality of magnet assemblies disposed within the yoke, the yoke comprising a plurality of cavities, each of the plurality of cavities being provided with one of the plurality of magnet assemblies, the plurality of magnetic gaps being formed between side walls of the plurality of cavities and outer side surfaces of the plurality of magnet assemblies located therein, and the yoke including a connecting channel located between the plurality of cavities and communicating the plurality of cavities.

2. The multi-magnetic circuit loudspeaker according to claim 1, wherein the yoke comprises a bottom plate, a plurality of arc-shaped side walls and connecting plates extending upward from the bottom plate, adjacent arc-shaped side walls are connected by the connecting plates, each of the plurality of arc-shaped side walls enclosing one of the plurality of cavities, the connecting channel being enclosed by two or more of the connecting plates, and portions of the plurality of magnetic gaps being located between the plurality of arc-shaped side walls and the plurality of magnet assemblies.

3. The multi-magnetic circuit loudspeaker according to claim 2, wherein a width of the connecting channel is less than diameters of the plurality of cavities.

4. The multi-magnetic circuit loudspeaker according to claim 2, wherein the plurality of arc-shaped side walls extend along circular arcs, central angles of the circular arcs are greater than or equal to 270 degrees and less than 360 degrees.

5. The multi-magnetic circuit loudspeaker according to claim 2, wherein two of the plurality of arc-shaped side walls are connected by two of the connecting plates, two cavities are communicated by one connecting channel, and the connecting channel is a straight channel.

6. The multi-magnetic circuit loudspeaker according to claim 1, wherein the multi-magnetic circuit loudspeaker further comprises a spider and a connecting bracket, the spider being fixed to the frame, an upper end portion of the connecting bracket being fixed to the diaphragm, and a lower end portion of the connecting bracket being fixed to the spider.

7. The multi-magnetic circuit loudspeaker according to claim 6, wherein the multi-magnetic circuit loudspeaker comprises a plurality of spiders symmetrically disposed, the plurality of voice coils or the magnetic circuit assembly being located between the plurality of spiders, each of the plurality of spiders having an outer edge fixed to the frame and an inner edge adjacent to the plurality of voice coils or the magnetic circuit assembly, and the lower end portion of the connecting bracket being fixed to the inner edge of each of the plurality of spiders.

8. The multi-magnetic circuit loudspeaker according to claim 1, wherein the frame comprises a pair of solder terminals, one lead wire of each of the plurality of voice coils is connected to one of the pair of solder terminals, and another lead wire of each of the plurality of voice coils is connected to the other one of the pair of solder terminals, and the plurality of voice coils are connected to each other in series or in parallel.

9. The multi-magnetic circuit loudspeaker according to claim 1, wherein the frame comprises a first frame and a second frame that are stacked, magnetic circuit mounting holes being arranged on the first frame and the second frame, respectively, and the yoke being disposed in the magnetic circuit mounting holes and fixed to hole walls of the magnetic circuit mounting holes.

10. The multi-magnetic circuit loudspeaker according to claim 9, wherein the multi-magnetic circuit loudspeaker further comprises a spider and a connecting bracket, the first frame comprises a hole portion, an outer edge of the spider is fixed to a lower surface of the first frame, an inner edge of the spider is fixed to a lower end portion of the connecting bracket, the connecting bracket passes through the hole portion, and an upper end portion of the connecting bracket is fixed to the diaphragm.

11. The multi-magnetic circuit loudspeaker according to claim 9, wherein the second frame comprises a vent hole, the multi-magnetic circuit loudspeaker further comprises a cloth that is sound-absorbing and breathable, the cloth covering the vent hole, and the cloth being fixed to an outer surface or an inner surface of the second frame.

12. The multi-magnetic circuit loudspeaker according to claim 1, wherein the magnetic circuit assembly comprises a single yoke.

13. An automotive audio system, comprising the multi-magnetic circuit loudspeaker according to claim 1.
